(19) United States
(12) Patent Application Publication
(10) Pub. No.: US 2007/0102919 A1
(43) Pub. Date: May 10, 2007

(54) Album with foldable internal pages

(76) Inventor: Deborah S. Karchmer, Houston, TX (US)

Correspondence Address: GORDON G. WAGGETT, P.C., 3200 SOUTHWEST FREEWAY, SUITE 2355, HOUSTON, TX, 77027, US

(21) Appl. No.: 11/592,609

(22) Filed: Nov. 3, 2006

Related U.S. Application Data
(60) Provisional application No. 60/733,712, filed on Nov. 3, 2005.

(51) Int. Cl. B42D 3/00

(52) U.S. Cl. 281/29

(57) ABSTRACT

The present invention relates generally to a novel album for containing photos, scrapbooking materials, memorabilia, handwriting and the like. More particularly, the present invention provides unique foldable structures to create a plurality of surfaces upon which to attach desired items. The foldable structures can also be used as printed invitations, announcements and the like. The foldable structures can employ, if desired, outer covers that have been created with desired decorative attributes. The foldable structures are capable of folding into a collapsed, compact position or being expanded to permit display of the contents contained on the plurality of surfaces. In any of the embodiments described herein, book can be displayed in a dosed fashion, or, owing to the unique fold lines, can be opened into various configurations to make display of the contents fan, interesting and varied.

This application clams the benefit of the filing date of copending U.S. Provisional Patent Application Ser. No. 60/733,712 filed Nov. 3, 2005, Confirmation No. 4503.

### STATEMENT REGARDING FEDERALLY SPONSORED RESEARCH OR DEVELOPMENT

Not Applicable.

### BACKGROUND OF THE INVENTION

The present invention relates to albums for containing photos, scrapbooking materials, memorabilia, handwriting and the like. More specifically, the present invention also relates to albums with foldable internal pages. The album can also be used as an invitation or a scrapbook. Scrapbooking is the fastest growing craft industry in the United States. Put simply, it is the practice of combining photographs, memorabilia, and written narratives, poetry, quotations, stories, or other textual content into a scrapbook style album. A few scrapbooks are mass produced, but most are unique, singular publications. They can contain an accumulation of all sorts of objects such as newspaper clippings, magazine articles, play bills, ticket stubs, pressed flowers, and locks of hair. Scrapbooks are often embellished with ribbons or other pieces of fabric, colorful graphics, and other artwork. These artifacts of history are attached to the album pages. Many different types of scrapbooks have been made including family histories, personal journals and memories, and historical records of organizations, military units, and other groups. New scrapbooking techniques, ideas, and products are in great demand.

Like scrapbooks, custom albums for special occasions such as new babies, weddings, and precious childhood memories are also becoming more popular. Often, these take the form of small photo albums, called “brag books,” featuring wire bindings or book-style stitched spines and easy-load photo pockets to hold twenty to forty 4 inch by 6 inch photographs. While not as large as traditional scrapbook style albums, they do allow the owner to carry several photographs in one convenient small booklet, albeit a booklet that features traditional boring photo pockets.

At the same time, there is more emphasis on creative display ideas such as tunnel books, popup books, accordion books, collages, and even photographs or writings being glued to large, simple origami structures. This last technique, origami, involves the Japanese art of paper folding to form models of almost all physical objects including animals, people, faces, plants, vehicles, and buildings. Not surprisingly, Japanese origami paper folding techniques are finding their way into American scrapbooking.

Accordingly, there is a need for a new album that incorporates some of these creative display ideas, principally the brag book and paper folding techniques.

### BRIEF SUMMARY OF THE INVENTION

The present invention provides a novel album for containing photos, scrapbooking materials, memorabilia, handwriting and the like. More particularly, the present invention provides unique foldable structures to create a plurality of surfaces upon which to attach desired items. The foldable structures can employ, if desired, outer covers that have been created with desired decorative attributes. The foldable structures are capable of folding into a collapsed, compact position or being expanded to permit display of the contents contained on the plurality of surfaces. The foldable structures can also be used as printed invitations, announcements and the like.

In general, as noted, the present invention relates to an album with foldable internal pages. The outer covers of the album are comprised of chipboards, a card-board like material, which are covered, at least in part, with an outer decorative cover. As might be expected, the colors, designs, prints, artwork, texture, and thickness for the outer decorative covers are virtually unlimited. The decorative covers are partially wrapped around and glued to the chipboards with a craft-appropriate adhesive or glue. The album includes unique foldable internal pages to which photographs or other memorabilia may be attached for display. In the present invention, a “stair step” folded paper design and a “cross” folded paper design are described. These internal folded paper designs are glued to the chipboard/decorative album covers. An accent ribbon tie may be added if desired.

The foregoing has outlined rather broadly the features and technical advantages of the present invention so that the detailed description of the invention that follows may be better understood. Additional features and advantages of the invention will be described hereinafter, which form the subject of the invention. It should be appreciated by those skilled in the art that the conception and the specific embodiments disclosed might be readily used as a basis for modifying or designing other albums for carrying out the same purposes of the present invention. It should also be realized by those skilled in the art that such equivalent constructions do not depart from the spirit and scope of the invention as set forth herein.

### BRIEF DESCRIPTION OF THE SEVERAL VIEWS OF THE DRAWINGS

The accompanying drawings, which are incorporated in and form a part of the specification, illustrate the embodiments of the present invention, and, together with the description, serve to explain the principles of the invention. In the drawings:

FIG. 1 shows two chipboards;

FIG. 2A shows two chipboards with attached outer decorative covers according to one preferred embodiment of the present invention;

FIG. 2B shows a chipboard with attached outer decorative cover according to another preferred embodiment of the present invention;

FIG. 3 shows how an outer decorative cover is folded at the four corners over a chipboard depicted in FIG. 2A;

FIG. 4 is a close-up view taken from view 4 of FIG. 3 of one corner of a decorative cover folded over a chipboard;

FIG. 5A shows how an outer decorative cover is folded along the edges over a chipboard depicted in FIGS. 2A and 3;

FIG. 5B shows how an outer decorative cover is folded along the edges over a chipboard depicted in FIG. 2B;

FIG. 6A is a close-up view taken from view 6A of FIG. 5A of one corner and two edges of a decorative cover folded over a chipboard;

FIG. 6B is a close-up view taken from view 6B of FIG. 5B of one corner and two edges of a decorative cover folded over a chipboard

FIG. 7A is an embodiment of an internal folded paper design (the “stair step” design);

FIG. 7B is another embodiment of an internal folded paper design (the “stair step” design);

FIG. 8 is an embodiment of an internal folded paper design (the “cross” design);

FIG. 9A shows how the “stair step” folded paper design is attached to the outer album covers;

FIG. 9B shows the attached outer covers of an embodiment according to the present invention;

FIG. 10 shows how the “cross” folded paper design is attached to the outer album covers;

FIG. 10A shows an enlarged view of surface 801 taken from view 10A of FIG. 10.

FIG. 11 shows a closed album with an accent ribbon tie;

FIG. 12A shows a top view another preferred embodiment of the present invention having a plurality of display faces created by the folds in the paper design (“the single unit squash design”), and having (optional) decorative covers attached;

FIG. 12B shows a perspective view of the embodiment of FIG. 12A depicting one way in which this embodiment can be folded;

FIG. 13A shows a top view another preferred embodiment of the present invention having a plurality of display faces created by the folds in the paper design (“the double unit squash design”), and having (optional) decorative covers attached;

FIG. 13B shows a perspective view of the embodiment of FIG. 13A depicting one way in which this embodiment can be folded;

FIG. 13C shows a top view another preferred embodiment of the present invention having a plurality of display faces created by the folds in the paper design, and having (optional) decorative covers attached;

FIG. 14A shows a top view another preferred embodiment of the present invention having a plurality of display faces created by the folds in the paper design (“the triple unit squash design”), and having (optional) decorative covers attached

FIG. 14B shows a perspective view of the embodiment of FIG. 14A depicting one way in which this embodiment can be folded;

FIG. 14C shows a perspective view of the embodiment of FIG. 14A depicting another way in which this embodiment can be folded; and

FIG. 15 illustrates the use of a cutting template (shown here in the shape of a triangle, but any shape can be used) which can be used to cut photos or other materials to a desired size and shape, such as a size and shape corresponding to the size and shape of one or more of the plurality of display faces.

It is to be noted that the drawings illustrate only typical embodiments of the invention and are therefore not to be considered limiting of its scope, for the invention will admit to other equally effective embodiments.

### DETAILED DESCRIPTION OF THE INVENTION

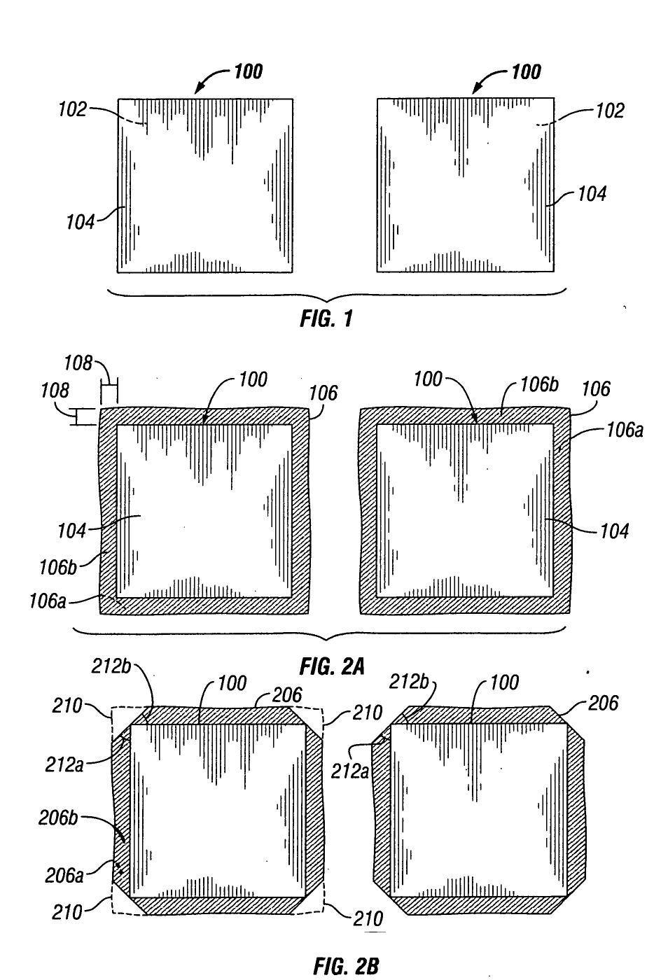

Turning now to FIG. 1, the outer cover of the album is comprised of chipboard 100 having an underside 102 and a topside 104. Chipboard is a cardboard-like material often used for the outer cover of books. More specifically, chipboard is a thin, hard-surfaced, grayish board, normally produced from paper stock, including waste papers. It has a relatively low density, and is available in thicknesses of 0.006 inch and up. Chipboards are easy to work with, widely available, and serve as an easy surface to which materials or fabrics may be attached. As is known in the art, all-purpose chipboard is often used for mounting, backing, book making, and constructing. It often has a smooth, uncoated surface on both sides. The color varies based on what recycled paper is available from the manufacturer. While any thickness of chipboard may be used in the present invention, such as 2-ply, 4-ply, 6-ply, 8-ply (or even thinner or thicker plys), the preferred chipboard is 4-ply chipboard. Instead of chipboard, the manufacturer could use melamine faced boards, polyester resin faced boards, MDF, thin particle boards, or similar materials.

In the present invention, a square-shaped chipboard 100 measuring about 4½ inches by 4½ inches is used. This size is convenient for holding photographs measuring 4 inches by 4 inches. This size and shape has an added convenience in that it looks good, fits in a person's hand or purse, is easy to carry, is lightweight and strong, and stands up while in the opened position. As is known in the art, other geometric shapes such as triangles, rectangles, circles, ovals, parallelograms, and the like may be used. Similarly, other sizes such as 8 inch by 8 inch squares, 4 inch by 6 inch rectangles, 8 inch diameter circles, or any other smaller or larger sizes can be used to hold photographs of any imaginable size or shape.

As is described in more detail below, the chipboard is covered, at least in part, with an outer decorative cover. When using the preferred 4½ inches by 4½ inches chipboard, the decorative cover measures about 6 inches by 6 inches square. Of course, other sizes and geometric shapes of the outer decorative cover may be used depending upon the thickness, size, and geometric shape of the chipboard, and depending upon the area of the chipboard which the manufacturer wishes to cover with the decoration.

Any mechanical, chemical, or other means known in the art may be used to attach the cover to the chipboard. More preferably, any commercially available adhesive or glue (such as animal glue) may be used to attach or apply the outer decorative cover to the chipboard. In one preferred embodiment, the manufacturer applies a 3M SCOTCH®-brand adhesive transfer tape to one side of the chipboard (here, underside 102) and then centers the chipboard 100, both vertically and horizontally, over and onto the cover 106, pushing down on the chipboard so that good adhesive contact is made with the cover. FIG. 2A shows two chipboards 100 with attached outer decorative covers 106 (having an underside 106a and a topside 106b). In this particular square embodiment, the cover 106 is also a square shape of a larger size than chipboard 100 so that there is a width of overhang 108 that is preferably equal in dimension around the perimeter of the chipboard 100, but variations in width can be used as well, and will also vary depending on the shape of the chipboard 100. In the alternative preferred embodiment shown in FIG. 2B, when the chipboard 100 is of a square shape the cover 206 is preferably cut so that each corner 210 (shown in ghost) is removed. In the square embodiment of FIG. 2A, the corners 210 of the cover 206 are preferably cut so that the resultant angles 212a, 212b of the cover 206 relative to the outer edges of the chipboard 100 total 90 degrees, each preferably being 45 degrees. With a suitable applicator, 3M SCOTCH®-brand adhesive transfer tape may be quickly and easily applied as a neat, precise strip of clean, dry adhesive to the surface of the chipboard. It is commonly found in ⅛ inch, ¼ inch, ⅜ inch, ½ inch, ⅝ inch, ¾ inch, ⅞ inch, and 1 inch width sizes.

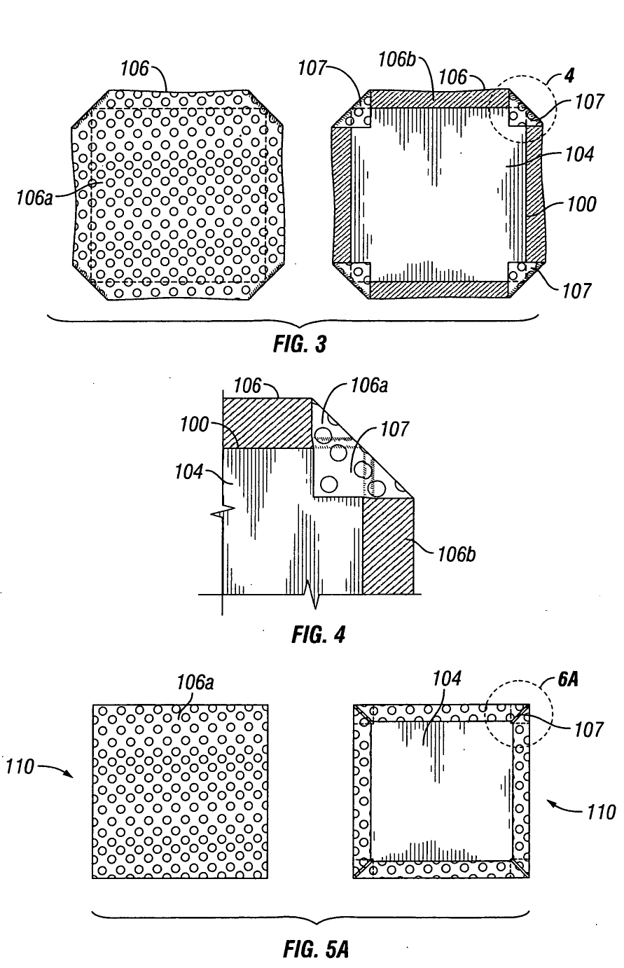

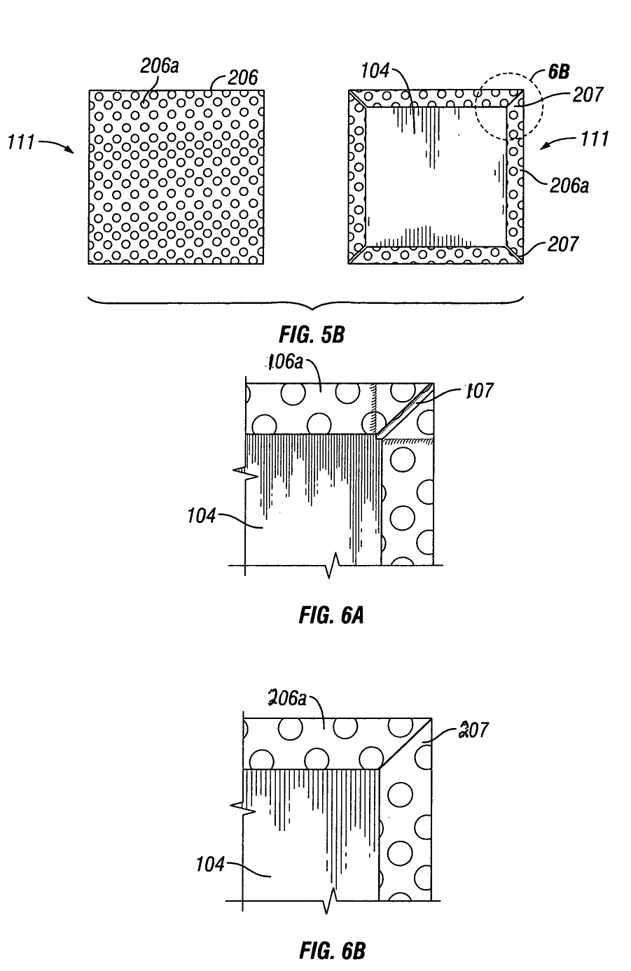

As seen in FIG. 3, after the chipboard 100 is “centered” and glued to the cover 106, the four corners 107 of the cover are then folded over the chipboard at approximately 90 degree angles, and held in place using a spot of ELMER'S®-brand craft glue or other suitable adhesive at the four corners of the chipboard. FIG. 4 is a close-up view taken from view 4 of FIG. 3 of one corner of a decorative cover folded over a chipboard. After the glue is allowed to dry, a “folding” bone is used to form a crease along the four sides (or edges) of the chipboard 100. More specifically, a 6 inch or 8 inch folding bone (not shown) can be swept along the length of the outer decorative cover for proper creasing and folding. The 3M SCOTCH®-brand adhesive transfer tape (or similar or other adhesive) can be used again on and along the four sides of the outer decorative cover 106, so that when the sides of the cover are folded along the formed creases, sufficient adhesive is available to attach the cover to the chipboard. FIGS. 5 and 6 show how an outer decorative cover is folded along the edges over a chipboard according to the embodiments described in FIGS. 2A and 2B. Specifically, FIG. 5A illustrates a covered chipboard 110 of the embodiment depicted in FIG. 2A, and FIG. 6A shows a close-up view (taken along view 6A of FIG. 5A) showing how the corner is covered. In the embodiment shown in FIG. 6A it is apparent that the material for the cover 106 will be thicker in the immediate region of the corner 107 owing to the fact that some of the cover material is folded back on top of itself. FIG. 5B illustrates a covered chipboard 111 of the embodiment depicted in FIG. 2B, and FIG. 6B shows a close-up view (taken along view 6B of FIG. 5B) showing how the corner 207 is covered. Unlike in the embodiment shown in FIG. 6A, the embodiment shown in FIG. 6B has flat corners 207 owing to the fact that removal of corner material 210 creates a smooth seam in the region of corner 207.

As might be expected for an outer decorative cover, the colors, designs, prints, artwork, texture, thickness, and so on for the material of construction or look of construction are virtually unlimited. For example, the cover can be made of hand-made paper, dyed paper, vinyl material, fabric, book cloth, suede, leather, scrap book paper, cotton paper, and the like with solid colors, shades, plaids, poke-a-dots, checkerboards, stripes, swirls, and color blends with contemporary, traditional, classical, or nouveau artwork and designs. The covers can be decorated with any possible style of decoration, such as, gemstones, precious stones, jewelry, beads, monograms, tassels, artwork, flowers, crystals, pins, lace, figurines, knick knacks, embellishments, etc., to name just a few. For the foldable album, two outer covers are to be constructed, which would typically be fashioned with coordinating materials, colors, and designs. Of course, there is no requirement that both covers be the same decoratively.

As is known in the art, there are other methods and techniques of applying the outer decorative cover to the chipboard including the use of spray adhesives, and other methods and techniques of folding and attaching the cover to the chipboard, all of which are encompassed by the present patent application.

The foldable album includes a unique internal folded paper design to which the subject photographs are attached for display. To begin, the paper may be of any finish, brightness, color, and weight. For example, the paper may be white, off-white, brown, black, grey, yellow, lime, green, pink, red, purple, blue, maroon, and the like, which would typically be fashioned with coordinating materials, colors, and designs as the two outer decorative covers. Most preferably, the internal folded paper is from about 60 to about 120 pound cover paper, most preferably 80 pound cover paper. Cover paper is a printing term used to describe a heavy, stiff paper such as card stock. If desired, acid-free card stock may be used. Paper which has had the acid removed from the pulp so that it has a neutral 7.0 pH is known as acid free paper. Acid free paper is commonly used for fine art prints and limited edition printing, as well as permanent records where contact with paper acidity could harm the documents or photographs.

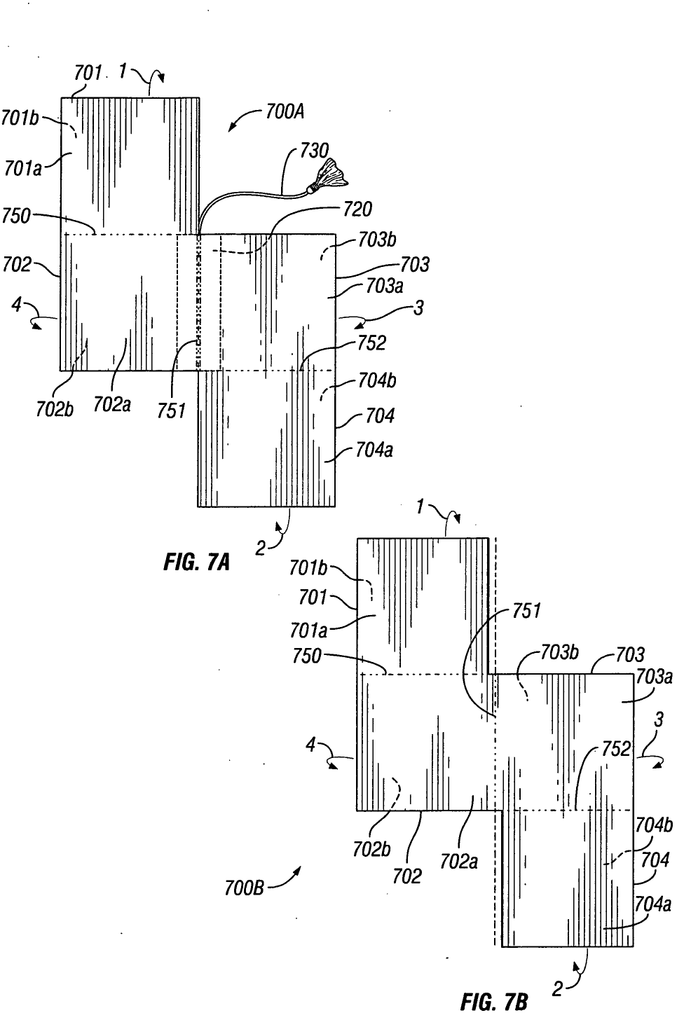

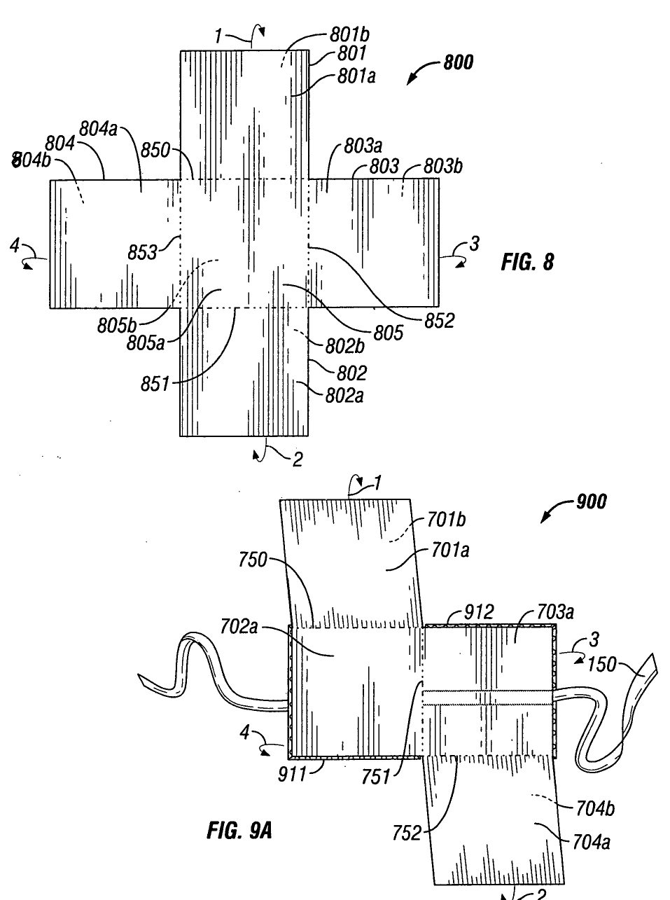

FIGS. 7 and 8 show two designs that can be internally folded to fit within the perimeter of the outer covers described above when closed. The “stair step” design 700A, 700B, of FIGS. 7A and 7B provides 4 square “surfaces” on each side (for a total of 8 surfaces)(701a, 701b, 702a, 702b, 703a, 703b, 704a and 704b) to which one or more photographs, scrapbook materials, notes, handwritings and the like may be attached. Here, each surface is about 4 inches by 4 inches in size, or slightly larger than 4 inches by 4 inches in size, to hold a 4 inch by 4 inch photograph, journal entry, scrapbook material or the like. Referring to FIGS. 7A and 7B the stair step design 700A, 700B has a topside “a” and an underside “b”, more specifically, the stair step design, when shown in a flat, unfolded position, takes the shape of four squares joined together as follows: square 701 (having topside 701a and underside 701b) is joined along its bottom edge to the top edge of square 702 (having topside 702a and underside 702b), the joinder of square 701 and 702 being represented by fold or score line 750; the right edge of square 702 is joined to the left edge of square 703 (having topside 703a and underside 703b), the joinder of square 702 and 703 being represented by fold or score line 751; square 703 is joined along its bottom edge to the top edge of square 704 (having topside 704a and underside 704b), the joinder of square 703 and 704 being represented by fold or score line 752. As constructed, square 701 can be folded along fold line 750 in the direction of arrow 1 so that surface 701a comes in contact with surface 702a. Square 704 can then be folded along fold line 752 in the direction of arrow 2 so that surface 704a comes in contact with surface 703a. Square 702 can then be folded along fold line 751 in the direction of arrow 4 so that surface 701b comes in contact with surface 704b to “close” the book. In this embodiment, surface 702b could serve as the front cover and surface 703b could serve as the back cover. Alternatively, as described later, surface 702b could be affixed to a decorative covering which can serve as the front cover and surface 703b could be affixed to a decorative covering which can serve as the back cover.

The “cross” design 800 of FIG. 8 provides 5 square “surfaces” on each side (for a total of 10 surfaces) to which one or more photographs, journal entries, scrapbook materials and the like may be attached. Referring to FIG. 8, the “cross” design 800 has a topside “a” and an underside “b”, more specifically, the cross design, when shown in a flat, unfolded position, takes the shape of five squares joined together as follows: square 801 (having topside 801a and underside 801b) is joined along its bottom edge to the top edge of square 805 (having topside 805a and underside 805b), the joinder of square 801 and 805 being represented by fold or score line 850; square 802 (having topside 802a and underside 802b) is joined along its top edge to the bottom edge of square 805, the joinder of square 802 and 805 being represented by fold or score line 851; square 803 (having topside 803a and underside 803b) is joined along its left edge to the right edge of square 805, the joinder of square 803 and 805 being represented by fold or score line 852; square 804 (having topside 804a and underside 804b) is joined along its right edge to the left edge of square 805, the joinder of square 804 and 805 being represented by fold or score line 853. As constructed, square 801 can be folded along fold line 850 in the direction of arrow 1 so that surface 801a comes in contact with surface 805a. Square 802 can then be folded along fold line 851 in the direction of arrow 2 so that surface 802a comes in contact with surface 801b. Square 803 can then be folded along fold line 852 in the direction of arrow 3 so that surface 803a comes in contact with surface 802b. Square 804 can then be folded along fold line 853 in the direction of arrow 4 so that surface 804a comes in contact with surface 803b to “close” the book. In this embodiment, surface 804b could serve as the front cover and surface 805b could serve as the back cover. Alternatively, as described later, surface 804b could be affixed to a decorative covering which can serve as the front cover and surface 805b could be affixed to a decorative covering which can serve as the back cover.

As described in more detail below, in one preferred embodiment, when constructed, one or more of these surfaces are not available for holding a photographs, etc. because one or more of the surfaces are used to glue, adhere, or otherwise connect to the outer decorative covers. However, in other preferred embodiments, the folded designs can be used without outer decorative covers.

These internal folded paper designs may be formed using a cutting template found at a commercial printing shop. These templates have metal scores and metal cutters for mass-producing the paper shapes desired. Of course, the overall shape of the folded paper designs, the location of the paper scores, and the size and shape of the surfaces to which photographs, etc. may be attached, would be dictated by the geometric shape and size of the chipboard and outer decorative covers. As is known in the art, scoring is essentially the embossing of a narrow ridge into the paper. It is done both to reduce or eliminate cracking and to determine a fold's location. There are several ways to score, but all methods are based on the same concept--the paper fibers are weakened by an indentation (hinge) in the paper. This produces a precise fold line (register) that reduces stress to the paper and permits a crisp fold.

In the embodiments of FIGS. 7A and 8, the dimensions of each square are approximately the same. The order in which the square “surfaces” are folded along the score lines are indicated by the numbered squares and arrow directions in FIGS. 7 and 8. When so folded, the front side and back side of several of the surfaces are both available for holding photographs or other desired content. As is known in the art, certain folds may require an allowance for short panels in order to enable the folded panels to nest properly. While helpful to the present discussion, the order of folding is not important if the album closes properly. For example, referring to FIG. 7B, the right edge of square 701 and the left edge of square 704 could be trimmed slightly so as not to bunch together along fold line 751. Likewise, in FIG. 8, the right and left edges of squares 801 and 802 could be slightly closer together than the right and left edges of squares 803 and 804.

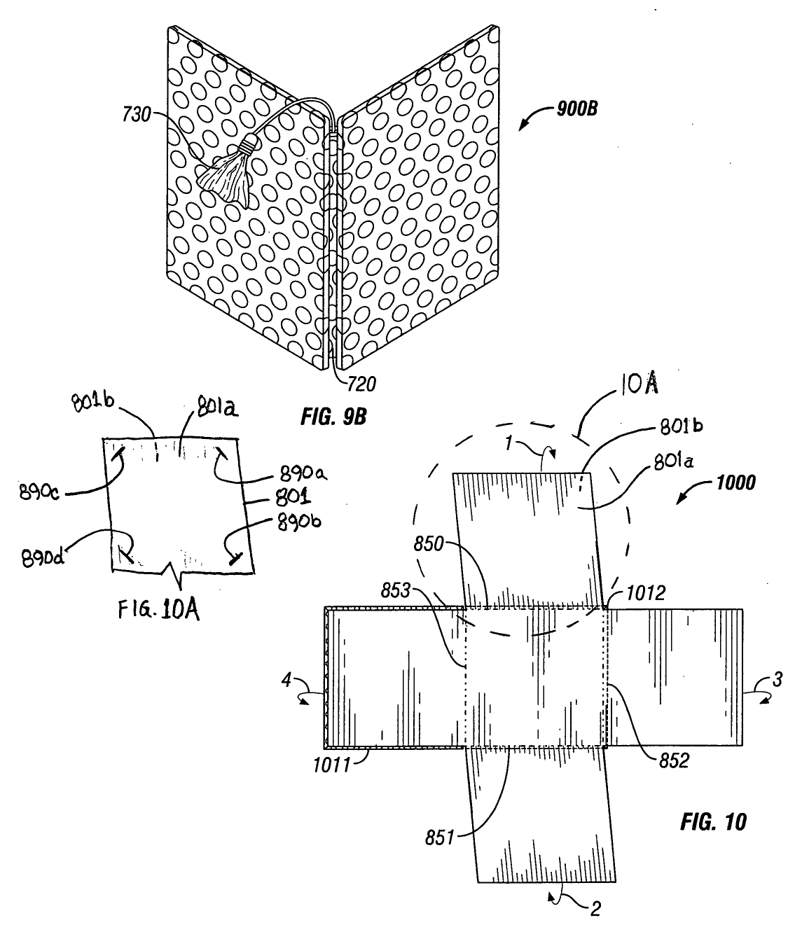

FIGS. 9A and 10 show how the “stair step” folded paper design and “cross” folded paper design are attached to the outer album covers, respectively to create finished products 900 and 1000. For example, decorative cover 911 could be glued or otherwise attached to surface 702b; decorative cover 912 could be glued or otherwise affixed to surface 703b. Similarly, decorative cover 1011 could be glued or otherwise attached to surface 804b; decorative cover 1012 could be glued or otherwise affixed to surface 805b. As before, the square surfaces are held to the outer covers using 3M SCOTCH®-brand adhesive transfer tape or similar adhesive.

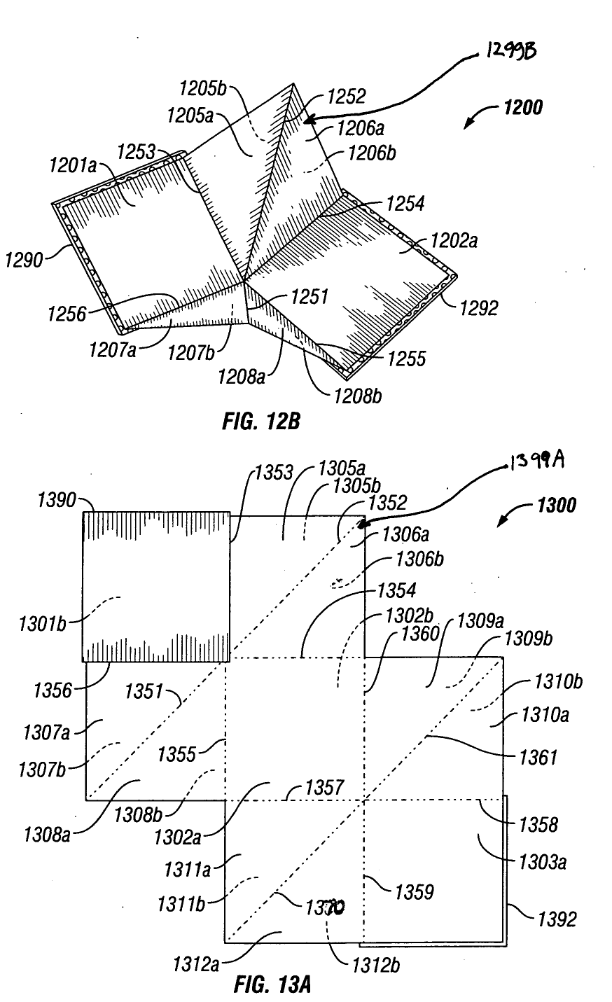

Referring now to FIGS. 12A, 12B. 13A. 13B, 13C, 14A, 14B and 14C, there are depicted a series of albums 1200, 1300, and 1400 shown with their respective sets of decorative covers (1290, 1292), (1390, 1392), and (1490, 1492) attached to their respective internal foldable structures 1299A, 1299B, 1399A, 1399B, 1399C, 1499A, 1499B and 1499C. These internal foldable structure embodiments could also exist without the use of their respective covers (1290, 1292), (1390, 1392), and (1490, 1492). The exemplary internal foldable structures provide a plurality of surfaces upon which one can attach photos, journal entries, scrapbook materials and the like.

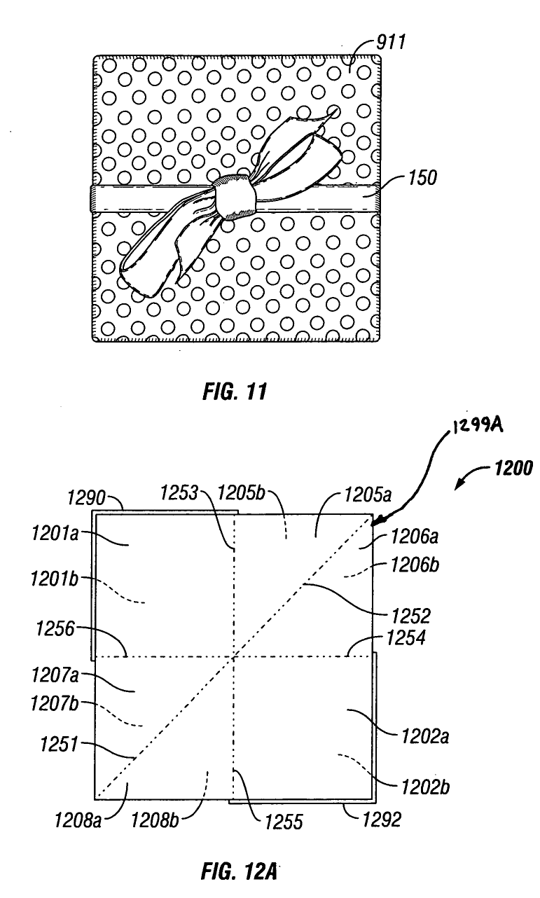

Referring to FIG. 12A, there is shown a preferred embodiment referred to as the “single unit squash design” utilizing a double-sided square-shaped paper having a topside (a) and an underside (b). This shape is divided into a plurality of separate top/underside surfaces (1201a, 1201b), (1202a, 1202b), (1205a, 1205b), (1206a, 1206b), (1207a, 1207b), (1208a, 1208b) by the use of fold or score lines 1253, 1252, 1254, 1255, 1251, and 1256. As will be appreciated, FIG. 12A depicts the internal foldable structure 1299A in a substantially unfolded (expanded) position, FIG. 12B depicts the internal foldable structure 1299A in a partially unfolded position, and FIG. 11 depicts the internal foldable structure 1299A (not shown) in a substantially folded position (e.g., collapsed position). When folded, the faces of undersides 1207b and 1208b will touch each other, as will the faces of undersides 1205b and 1206b. Top side sections 1205a and 1207a will touch top face section 1201a. Top face sections 1206a and 1208a will touch top face 1202a. When completely folded, the folded structure will be the size of section 1201a. The underside surface 1201b and the underside surface 1202b will now be the outside “covers”, much like the front and back covers of a book. In an alternative embodiment, the underside 1201b and the underside 1202b can be attached (glued) to separate structures 1290, 1292 that serve as covers.

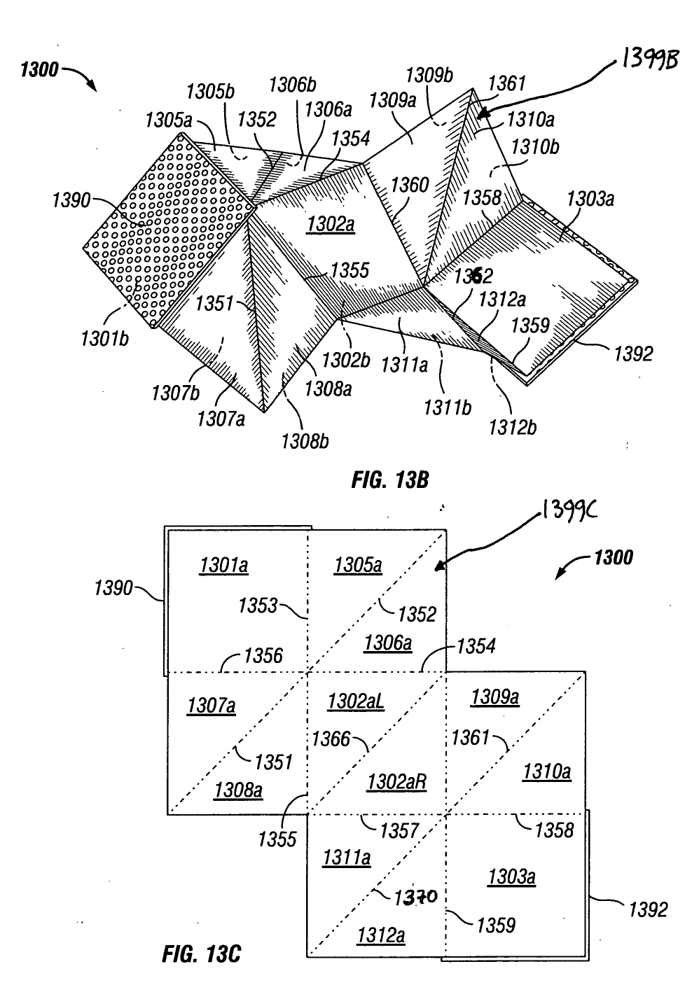

Referring to FIG. 13A, there is a similar embodiment to that depicted in FIG. 12A except that an additional “square” of internal folded structure has been added in an overlapping fashion. In FIG. 13A, there is shown a preferred embodiment referred to here as the “double unit squash design” utilizing a double-sided square-shaped paper having a topside (a) and an underside (b). This shape is divided into a plurality of separate top/underside surfaces (1301a, 1301b), (1302a, 1302b), (1305a, 1305b), (1306a, 1306b), (1307a, 1307b), (1308a, 1308b), (1309a, 1309b), (1310a, 1310b), (1303a, 1303b), (1311a, 1311b), (1312a, 1312b) by the use of fold or score lines 1353, 1352, 1354, 1355, 1351, 1356, 1361, 1358, 1359, 1370, 1357. As will be appreciated, FIG. 13A depicts the internal foldable structure 1399A in a substantially unfolded (expanded) position, FIG. 13B depicts the internal foldable structure 1399B in a partially unfolded position, and FIG. 11 depicts the internal foldable structure 1399A (not shown) in a substantially folded position (e.g., collapsed position). Folding about the score lines permits the internal foldable structure 1399A, 1399B to collapse into a nested square the approximate size of surface 1302a. Additionally, interesting formations can be attained depending on the direction each fold is made resulting, alternatively, in a folded structure, while perhaps partially nested, that does not result in a nested square shape the size of surface 1302a.

FIG. 13C is a slight variation of FIG. 13A in that it contains one additional fold or score line 1366. The top left half of this now-divided quadrant 1302a is called 1302aL, the lower right half is called 1302aR (with the respective undersides called 1302bL and 1302bR). In this embodiment, this additional score line permits symmetrical folding about score line 1366. As such, if covers are employed, cover 1390 would be attached to top surface 1301a.

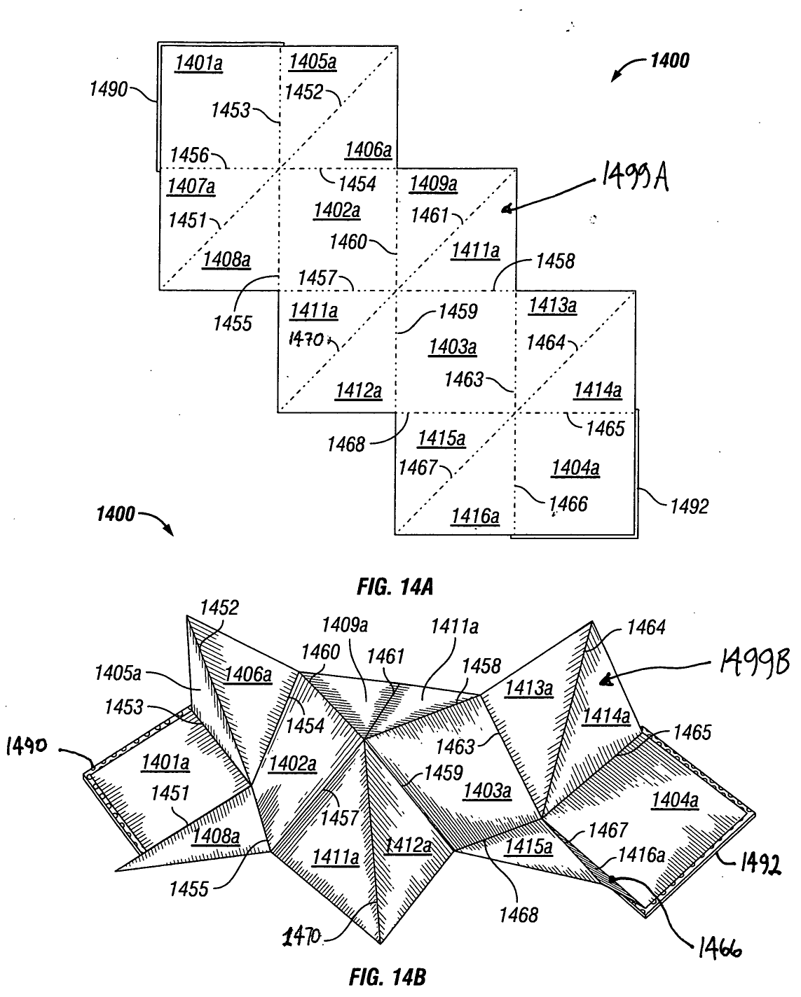

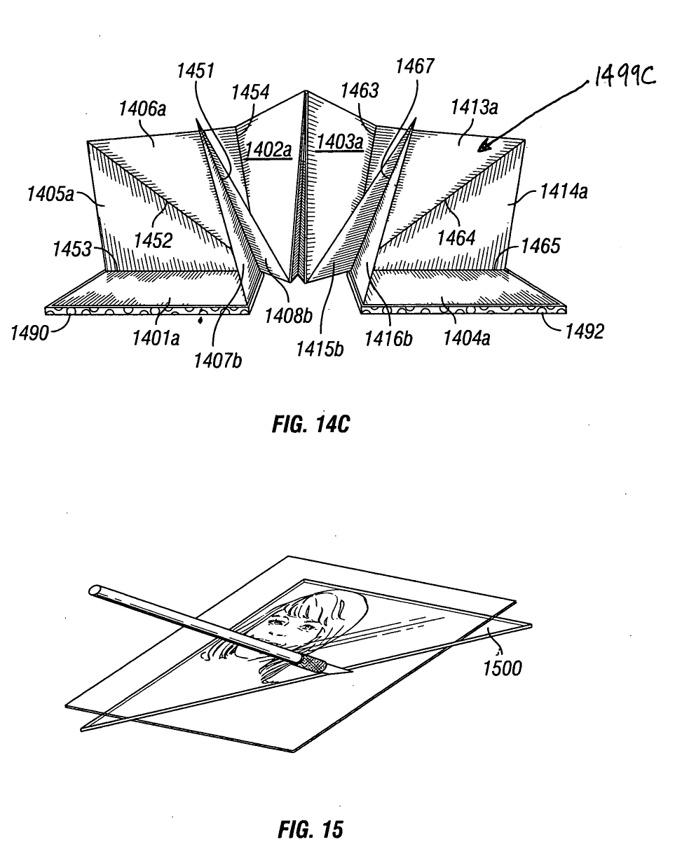

Referring now to FIG. 14A, there is a similar embodiment to that depicted in FIG. 13A except that an additional “square” of internal folded structure has been added in an overlapping fashion. In FIG. 14A, there is shown a preferred embodiment referred to as the “triple unit squash design” utilizing a double-sided square-shaped paper having a topside (a) and an underside (b). This shape is divided into a plurality of separate top/underside surfaces (1401a, 1401b), (1402a, 1402b), (1405a, 1405b), (1406a, 1406b), (1407a, 1407b), (1408a, 1408b), (1409a, 1409b), (1410a, 1410b), (1403a, 1403b), (1411a, 1411b), (1412a, 1412b), (1413a, 1413b), (1414a, 1414b), (1404a, 1404b), (1416a, 1416b), (1415a, 1415b) by the use of fold or score lines 1453, 1452, 1454, 1455, 1451, 1456, 1461, 1458, 1459, 1470, 1457, 1463, 1464, 1465, 1466, 1467, 1468. As will be appreciated, FIG. 14A depicts the internal foldable structure 1499A in a substantially unfolded (expanded) position, FIG. 14B depicts the internal foldable structure 1499A in a partially unfolded position, and FIG. 11 depicts the internal foldable structure 1499A (not shown) in a substantially folded position (e.g., collapsed position). Folding about the score lines permits the internal foldable structure 1499A, 1499B to collapse into a nested square the approximate size of surface 1402a. Additionally, interesting formations can be attained, such as depicted in FIG. 14C depending on the direction each fold is made resulting, alternatively, in a folded structure, while perhaps partially nested, does not result in a nested square shape the size of surface 1302a.

As will be appreciated, the placement of score lines can be adjusted to achieve a desired folding shape or pattern, whether symmetrical, asymmetrical or otherwise.

After the album is completed, the user can add one or more photographs (or other memorabilia) to the various square or other shaped “surfaces” available on the internal folded paper. Referring to FIG. 15, a very thin clear (or near clear) plastic template 1500 of desired shape may be provided with the album to help the user trim the photographs (with razorblade, knife, decorative-edged scissors and the like) to fit the square (or other shaped) surfaces. The photographs can be added using photo corners or sticker mounts. Photo corners offer a quick, easy, and cheap way to display valuable photos without damaging or altering them in the process. More specifically, acid-free archival-quality mounting corners are available in clear and a variety of colors and sizes for the user's specific needs. Alternatively, the photographs can be glued to the surfaces using a suitable acid-free glue stick or similar adhesive. And, instead of photographs, items such as movie tickets, memorabilia, or journal notes found in scrapbook-style albums may be added to the present album. Additionally, referring to FIG. 10A, there is depicted a square-shaped foldable surface 801 containing slits (890a, 890b, 890c, 890d) that have been cut proximate the corners of the surface 801. A user could place all four corners of a photo or other desired memorabilia into the corners to secure the photo to one side (e.g., 801a) of the surface 801. However, if the user places a first photo only into diagonally opposed corners 890c and 890b on side 801a, then a second photo or other material could be secured on the reverse side 801b by using the other two available corner slits 890d and 890a.

If desired, prior to attaching the internal folded paper to the outer decorative cover, an accent ribbon tie or sash 150 may be added. The sash 150 can be made of various materials, colors, textures, and designs, typically complementary to the internal folded paper and outer decorative covers. For example, the sash may be made of fabric, silk, satin, suede, printed polyester, or various cloths of any conceivable color or design with varying widths such as from about ⅜ inch to about ⅞ inch. To add the ribbon, 3M SCOTCH®-brand adhesive transfer tape or similar adhesive may be applied near the middle of, and across the length of, the outer decorative cover. Before it dries, the ribbon or sash is then placed along the adhesive and pushed down so that good adhesive contact is made with the cover. The length of the sash would typically be longer than the combined outer length of the two outer decorative covers. For example, when the covers are placed on a 4½ inches by 4½ inches chipboard, the sash is from 10 inches to 12 inches in length, such that a ribbon tie or “shoe laces” bow can be formed to close and secure the two outer decorative covers. After the sash is glued in place (when desired), the folded internal paper is then glued onto the outer decorative cover using SCOTCH®-brand transfer tape or similar adhesive. The sash or ribbon could also be added in other ways known to those of skill in the art.

Referring now to FIG. 9B, there is depicted an album cover 900B shown in a partially open fashion (the internal folding pages are not shown). In this embodiment, a decorative spine material 720 (see also FIG. 7A) can be attached between each of the decorative covers, e.g., 911, 912. In another preferred embodiment, a sash 730 can be attached to the spine material 720 as well. FIG. 11 shows a closed album, such as that depicted in FIG. 9A, with an accent ribbon tie 150. In another preferred embodiment of the present invention, the internal folded paper designs described herein can be used without any outer covers.

Based on the teachings herein, novel albums, scrapbooking, photo album or notepad/journal and invitation designs can be created. Furthermore, as an additional preferred embodiment to the present invention, there is described a kit for making these books. The kit can contain any combination of the following: I. premade albums/journals/books according to the present invention or II. Materials for making these books (glue, chipboard, assorted fabrics, assorted foldable structures, etc.; in combination with (a) Decorative-edged scissors, razor knife, cutting templates; (b) glue; (c) photo mounts, (d) scrapbook supplies. In any of the embodiments described herein, book can be displayed in a closed fashion, or, owing to the unique fold lines, can be opened into various configurations to make display of the contents fun, interesting and varied.

Although the present invention and its advantages have been described in detail, it should be understood that various changes, substitutions, and alterations could be made herein without departing from the spirit and scope of the invention as described herein. While the apparatus of this invention have been described in terms of preferred embodiments, it will be apparent to those of skill in the art that variations may be applied to the embodiments described herein without departing from the concept and scope of the invention. All such similar substitutes and modifications apparent to those skilled in the art are deemed to be within the scope and concept of the invention.

1. An album for containing photos, memorabilia, printed matter or written matter comprising:
(a) a foldable structure capable of occupying a first, compact position and a second, expanded position;
(b) a plurality of scoring lines in the foldable structure to create a desired pattern of folds; and
(c) a plurality of surfaces on said foldable structure created by the desired pattern of folds for receiving the photos, memorabilia, printed matter or written matter.

2. The album of claim 1, further comprising a set of covers for covering the foldable structure when said foldable structure occupies said compact position.

3. The album of claim 2, wherein the covers each comprise chipboard covered with a decorative surface material.

4. The album of claim 1 wherein the desired pattern of folds comprises square shapes and triangular shapes.

5. The album of claim 1 wherein said album is a photo album, scrapbook, announcement, invitation, or diary.

6. The album of claim 1 further comprising attached decorations.

7. The album of claim 1 wherein said foldable structure comprises a stair step design.

8. The album of claim 1 wherein said foldable structure comprises a cross design.

9. The album of claim 1 wherein said foldable structure comprises a single unit squash design.

10. The album of claim 1 wherein said foldable structure comprises a double unit squash design.

11. An album kit comprising: (a) an album, (b) decorative-edged scissors or razor knife, (c) cutting templates, (d) adhesive, and (e) photo mounts.

12. The kit according to claim 11 further comprising scrapbook supplies.
